(19) United States
(12) Patent Application Publication
(10) Pub. No.: US 2012/0096144 A1
(43) Pub. Date: Apr. 19, 2012

(54) METHOD AND APPARATUS FOR FETCHING DATA BASED ON NETWORK CONDITIONS

(75) Inventor: Jonathan Ledlie, Cambridge, MA (US)

(73) Assignee: Nokia Corporation, Espoo (FI)

(21) Appl. No.: 12/906,711

(22) Filed: Oct. 18, 2010

(51) Int. Cl. G06F 15/173

(52) U.S. Cl. 709/224; 709/225

(57) ABSTRACT

An approach is provided for fetching data based on network conditions. A network management platform determines an anticipated availability of one or more networks associated with a device. The network management platform then determines one or more data requests, one or more anticipated data requests, or a combination thereof of one or more applications associated with the device. Based, at least in part, on the anticipated availability, the network management platform determines to generate a schedule for completing the one or more data requests, the one or more anticipated data requests, or a combination thereof

### BACKGROUND

Service providers (e.g., wireless, cellular, etc.) and device manufacturers are continually challenged to deliver value and convenience to consumers by, for example, providing compelling network services. However, many of these services (e.g., maps, music, video, electronic books, etc.) can be quite data intensive and involve transfers of significant amounts of data between client devices and the services. As a result, service providers and device manufacturers face significant technical challenges to enabling efficient and timely delivery of content to support these services, particularly when a client device has only intermittent connection to a communication network or has network connectivity that varies in availability, quality, bandwidth (e.g., low or high bandwidth networks), costs, and the like.

### SOME EXAMPLE EMBODIMENTS

Therefore, there is a need for an approach for efficiently fetching data (e.g., service content) based on communication network conditions (e.g., availability, bandwidth, etc.).

According to one embodiment, a method comprises determining an anticipated availability of one or more networks associated with a device. The method also comprises determining one or more data requests, one or more anticipated data requests, or a combination thereof of one or more applications associated with the device. The method further comprises determining to generate a schedule for completing the one or more data requests, the one or more anticipated data requests, or a combination thereof based, at least in part, on the anticipated availability.

According to another embodiment, an apparatus comprising at least one processor, and at least one memory including computer program code, the at least one memory and the computer program code configured to, with the at least one processor, cause, at least in part, the apparatus to determine an anticipated availability of one or more networks associated with a device. The apparatus is also caused to determine one or more data requests, one or more anticipated data requests, or a combination thereof of one or more applications associated with the device. The apparatus is further caused to determine to generate a schedule for completing the one or more data requests, the one or more anticipated data requests, or a combination thereof based, at least in part, on the anticipated availability.

According to another embodiment, a computer-readable storage medium carrying one or more sequences of one or more instructions which, when executed by one or more processors, cause, at least in part, an apparatus to determine an anticipated availability of one or more networks associated with a device. The apparatus is also caused to determine one or more data requests, one or more anticipated data requests, or a combination thereof of one or more applications associated with the device. The apparatus is further caused to determine to generate a schedule for completing the one or more data requests, the one or more anticipated data requests, or a combination thereof based, at least in part, on the anticipated availability.

According to another embodiment, an apparatus comprises means for determining an anticipated availability of one or more networks associated with a device. The apparatus also comprises means for determining one or more data requests, one or more anticipated data requests, or a combination thereof of one or more applications associated with the device. The apparatus further comprises means for determining to generate a schedule for completing the one or more data requests, the one or more anticipated data requests, or a combination thereof based, at least in part, on the anticipated availability.

According to another embodiment, a method comprises facilitating access to at least one interface configured to allow access to at least one service, the at least one service configured determine an anticipated availability of one or more networks associated with a device. The at least one service is also caused to determine one or more data requests, one or more anticipated data requests, or a combination thereof of one or more applications associated with the device. The at least one service is further caused to determine to generate a schedule for completing the one or more data requests, the one or more anticipated data requests, or a combination thereof based, at least in part, on the anticipated availability.

According to another embodiment, a computer program product including one or more sequences of one or more instructions which, when executed by one or more processors, cause an apparatus to determine an anticipated availability of one or more networks associated with a device. The apparatus also caused to determine one or more data requests, one or more anticipated data requests, or a combination thereof of one or more applications associated with the device. The apparatus is further caused to determine to generate a schedule for completing the one or more data requests, the one or more anticipated data requests, or a combination thereof based, at least in part, on the anticipated availability.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for fetching data based on network conditions, according to one embodiment;

FIG. 2 is a diagram of components of a network management platform, according to one embodiment;

FIG. 3 is a flowchart of a process for generating a schedule for fetching data based on network conditions, according to one embodiment;

FIG. 4 is a flowchart of a process for determining characteristics of a network for fetching data, according to one embodiment;

FIG. 5 is a flowchart of a process for determining to transmit data requests based on network conditions, according to one embodiment;

FIG. 6 is a flowchart for generating notifications to servers providing responsive information to data requests, according to one embodiment;

FIGS. 7A-7C are diagrams of user interfaces utilized in the processes of FIGS. 3-5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for fetching data based on network conditions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

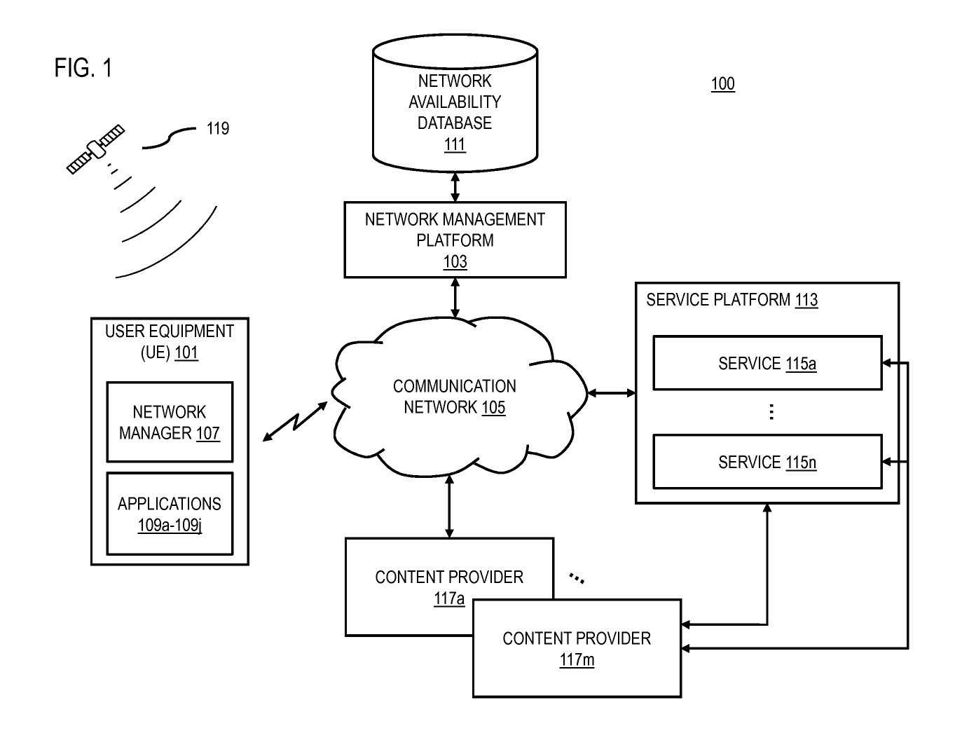

FIG. 1 is a diagram of a system for fetching data based on network conditions, according to one embodiment. As previously noted, user devices (e.g., mobile devices such as cell phones, smartphones, tablets, portable computers, etc.) often are connected to communication networks of various conditions and/or capabilities. For example, depending on a device's location, the device may be in a network environment with no or otherwise limited cellular connection (e.g., in remote locations or locations where cellular signals may not penetrate). At another location, the device may have access to high-speed cellular data networks and/or other wireless networks (e.g., WiFi networks, local area networks) where data can be transferred more quickly or at lower cost. Historically, despite varying network conditions, network demands generated by applications executing at the device often remain substantially the same. Consequently, low or limited bandwidth environments can quickly become overloaded, thereby resulting in poor network performance and a poor user experience.

To address this problem, a system 100 of FIG. 1 introduces the capability to predict or anticipate the availability of one or more networks and to pre-fetch data (e.g., content) during the anticipated availability for use by one or more applications executing on a user device. In some embodiments, the system 100 can additionally and/or alternatively anticipate when network conditions (e.g., available bandwidth, duration of availability, quality of service (QoS), data caps, etc.) will meet predetermined targets and/or limits to support retrieving the data. Based at least in part on the anticipated availability of the one or more networks, the system 100 can determine, predict, and/or schedule data requests that will be generated or needed by the applications. In this way, the system 100 can pre-fetch and cache data that might be used by the applications when the network is available. The pre-fetched data is then accessible to the applications even when the network conditions might limit or otherwise restrict such access over the network.

In one embodiment, the system 100 collects historical data or information on the availability of the networks to enable the system 100, for instance, to determine patterns of the network availability and anticipate when and for how long one or more networks will be available for data transfer. In one embodiment, the historical data and corresponding anticipated availability is determined on a network-by-network basis. By way of example, in one sample use case, a farmer may routinely travel to remote locations of his farm where there only low-bandwidth data connections (e.g., low-bandwidth cellular data) during the week days and return to his main farmhouse during the weekend wherein high-bandwidth data connections (e.g., a WiFi connection) are available. During the week the farmer needs access to mapping information for a map application to precisely locate planting areas. However, downloading the mapping information while in the field can be extremely slow and/or costly for the farmer (e.g., if the low-bandwidth cellular data connection is more expensive than the WiFi connection). In this case, the system 100 can learn the monitor the farmer's location and when he enters or exits various networks to determine a pattern of network availability. For example, the system 100 can determine that the farmer is in a high-bandwidth environment during the weekends. Accordingly, the system 100 can schedule data requests and/or anticipated data requests (e.g., mapping information covering particular sections of the farm) to be completed during the weekends. The mapping information will then be available for use by the farmer during the following work week, thereby minimizing the use of the low-bandwidth connection available in the field.

In some embodiments, the user associated with the device (e.g., the farmer) can provide feedback to the system 100 regarding whether the fetched/pre-fetched content anticipates the user's data needs. By way of example, the feedback may be provided explicitly (e.g., by direct input from the user rating the fetched content). In addition or alternatively, the feedback may be provided implicitly based on whether the fetched content was accessed by the user.

In yet another embodiment, the system 100 may schedule and/or fetch content for a plurality of applications during the anticipated network availability. In some embodiments, the system 100 may attempt complete all data requests and anticipated data requests during the period in which the network is available (e.g., completing each request on a first come/first served approach). In other embodiments, the system 100 may prioritize the applications and/or their data requests based on historical information, user input, learning, and the like. Based, on the determined priority, the system 100 can then schedule the data requests based on when and how long the network is predicted to be available.

In one embodiment, the network availability is based, at least in part, on respective bandwidth capacities, bandwidth limitations, etc. of the one or more networks. As used herein, the term bandwidth capacity refers to either a theoretical or measured capacity of the network. For example, the bandwidth capacity can refer to a speed of the network connection (e.g., 1 Mbps), a total cap or allotment of bandwidth (e.g., a maximum of 200 MB per month), and/or the like. In one embodiment, the bandwidth capacity is based on estimates and/or measurements of the bandwidth previously attained over the network. For example, the bandwidth capacity can be calculated as an average of previous bandwidth measurements made by one or more devices operating over the network. In another embodiment, the devices can then share the measurements to estimate the bandwidth capacity. The term bandwidth limitations refer to, for instance, user-defined limits on how bandwidth capacity is to be used by the system 100 for implementing the approach described herein. For example, the user may limit the system 100 to 75% of the bandwidth capacity. In another example, the user may specify a dollar amount for the cost of the bandwidth or another measure of network condition (e.g., QoS, available duration, etc.) as limits. In one embodiment, on first joining a network, the system 100 can suggest one or more bandwidth limits and/or request the limits from the user. By way of example, the bandwidth limit may be suggested based on collaborative filtering of limits applied by other users.

In some embodiments, the bandwidth limitations may be used as targets or criteria for determining whether a particular network should be used for completing scheduled data requests. For example, if the network meets a target of at least 0.75 Mbps bandwidth speed, then the network can be used for completing the data requests.

In another embodiment, the system 100 can generate notifications to servers or services that have or might have information responsive to the requests. The notifications alert the servers of upcoming data requests so that responsive information can be prepared for quicker transmission to the device is in its network availability period. In another embodiment, the notification may include anticipate location information for the device. In this case, the server can transmit at least a portion of the responsive information to an intermediate device (e.g., a network-enabled personal computer accessible by the device) at a location where the device is expected. When the device reaches the location, the device may retrieve the information via a connection (e.g., a wired or wireless connection) to the intermediate device.

Under the approach described herein, the system 100 advantageously enables both the user device and the network to reduce the potential to overburden a low-bandwidth network environment. In addition, the system 100 advantageously enables the user to define limits for when data should be retrieved that can be enforced by the system 100 to improve the responsiveness of executing applications and potentially reduce bandwidth costs to the user.

As shown in FIG. 1, the system 100 comprises a UE 101 having connectivity to a network management platform 103 via a communication network 105. In one embodiment, the network management platform 103 determines the data (e.g., application data) fetching based on network conditions as described herein. In addition or alternatively, the UE 101 may execute a network manager 107 to perform all or a portion of the functions of the network management platform 103. By way of example, the network management platform 103 and/or network manager 107 interacts with one or more applications 109a-109j to determine and schedule one or more data requests, one or more anticipated data requests, or a combination thereof based on the anticipated availability of the communication network 105. As previously, described the anticipated availability may describe the network conditions (e.g., speed, capacity, limits, etc.) and/or an anticipated duration for the availability. The availability information and data for determining the availability information (e.g., historical information, user preferences, application history, etc.) is stored in, for instance, the network availability database 111.

In one embodiment, the applications 109a-109j are clients of or otherwise request data from the service platform 113, its one or more services 115a-115n, the content providers 117a-117m, and/or any other data provider available over the communication network 105. For example, a service 115a (e.g., a mapping service) may obtain content (e.g., mapping information or data) from a content provider 117a to deliver data or content to the UE 101 and/or one or more of the applications 109a-109j. In one embodiment, the network management platform 103 may initiate delivery of the content in response to one or more data requests or anticipated data requests from the applications 109a-109j based on determining one or more anticipated availability periods of the communication network 105.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.). In one embodiment of the approach described herein, the UE 101 may include one or more mechanisms for measuring bandwidth capacity and for sharing the measurements to other devices.

As noted above, the UE 101 may include the network manager 107 that operates in place of or in coordination with the network management platform 103. In one embodiment, the network manager 107 and/or the network management platform 103 is capable of handling various operations related to scheduling and/or allocating available bandwidth to any of the applications 109a-109j of the UE 101. For example, the network manager 107 may manage incoming or outgoing content via the UE 101. In one embodiment, the network manager 107 provides a user interface to enable the user to specify user preferences, limitations, targets, prioritizations, etc. for managing the use of available network resources (e.g., bandwidth). Further, the network manager 107 and/or network management platform 103 may include interfaces (e.g., application programming interfaces (APIs)) that enable communication with the applications 109a-109j, the service platform 113, the services 115a-115n, the content providers 117a-117m, or a combination thereof for performing the processes described herein.

By way of example, the UE 101, the network management platform 103, the service platform 113, and the content providers 117a-117m communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the network manager 107 and the network management platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

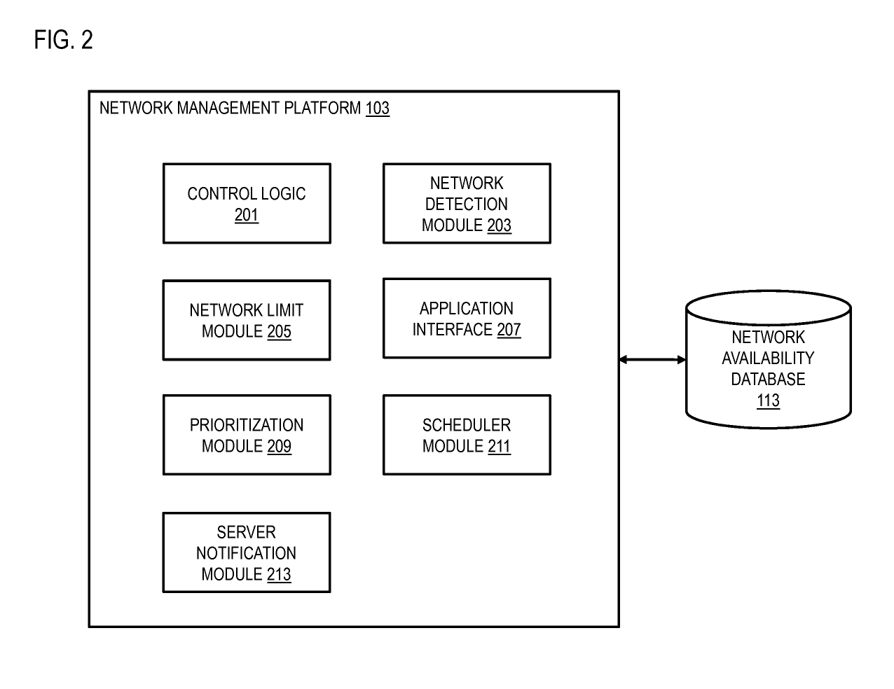

FIG. 2 is a diagram of the components of a network management platform, according to one embodiment. By way of example, the network management platform 103 includes one or more components for fetching data based on network conditions. It is contemplated that the functions of these components may be combined in one or more components or performed by other components of equivalent functionality. In this embodiment, the network management platform 103 includes at least a control logic 201 which executes at least one algorithm for performing functions of the network management platform 103. For example, the control logic 201 interacts with a network detection module 203 to determine when the UE 101 has connectivity to one or more networks. In one embodiment, the network detection module 203 can determine whether and detected network is a new network or a previously joined network. In either case, the network detection module 203 can generate one or more records to document the detected network for storage in, for instance, the network availability database 111. In some embodiments, the network detection module 203 can query the detected network to information to identify the network and/or one or more of its characteristics (e.g., network type, bandwidth capacity, service provider, availability, security features, etc.).

If the detected network is a new network (e.g., the UE 101 has not previously joined the detected network), the network detection module 203 interacts with the network limit module 205 to determine any limitations and/or targets to apply to the detected network. In one embodiment, the network limit module 205 presents a user interface that enables a user to specify the bandwidth limits (e.g., time-based limits, percent of capacity limits, cost limit, etc.). In some embodiments, the network limit module 205 may, for instance, cooperate with network operators to set bandwidth limits and targets on a per-user level (including across devices associated with the user). This enables the network operators to advantageously manage the network load and/or traffic over the network. For example, when a user joins a network, the network limit module 205 may present a recommended target or limit based on input from the network operators. In one embodiment, the recommended limits may be provided by the network operators as an extension of the network announcement protocol. In one embodiment, the recommended bandwidth limits can be made using collaborative filtering if the network limit module 205 has access to bandwidth suggestions provided to and/or applied by other users over the network (e.g., as stored or otherwise made available in the network availability database 111).

The network management platform 103 also includes an application interface 207. The application interface 207 enables any of the applications 109a-109j to communicate with the network management platform 103 to determine whether the applications 109a-109j can complete any of its data requests or anticipated data requests during a particular network availability period. The application interface 207 can also provide access to a prioritization module 209 that enables a user to directly or explicitly specify a priority of the list of applications 109a-109j with pending or anticipated data requests. In one embodiment, the prioritization module 209 can learn or predict a priority of the applications 109a-109j based, at least in part, on historical use information, context information associated with the UE 101 (e.g., location, activity, time, etc.), or a combination thereof. For example, if a UE 101 regularly attempts to download large files for an application in bandwidth-starved environments, the prioritization module 209 can increase the application's priority to increase its chance of being able to download the large files when the UE 101 is connected to a high-bandwidth network. By way of example, such large files may include map updates, software updates, and the like. Other examples include video or audio highlights or “podcasts” that a user has either directly subscribed to or the network management platform 103 has predicted that the user would be interested in.

Using information on the detected networks, the pending or anticipated data requests, the prioritization of the applications 109a-109j and/or their data requests, or a combination thereof, the scheduler module 211 can generate a schedule for completing the as many of the data requests as possible during periods when the platform 103 has detected sufficient network connectivity. In one embodiment, the schedule relates to an inactive or “offline” application, the scheduler module 211 can initiate activation of the inactive application so that the inactive application can still benefit from pre-fetching data during a network availability period.

In one embodiment, by observing or monitoring historical network availability information (e.g., location information associated with the UE 101 and the UE's 101 location with respect to one or more network coverage or connectivity areas), the duration that the UE 101 will be connected to a high- or low-target bandwidth can be estimated. For example, the scheduler module 211 may predict that the UE 101 will be connected to a no-limit network (or other network that meets a predetermined network condition target) for a particular period of time (e.g., 10 minutes). Instead of always allocating or scheduling the whole period to an application with highest priority, the scheduler module 211 may divide the available time among a set of applications 109a-109j, so that if the user wanted to use any one of the applications 109a-109j when in a bandwidth-starved environment, at least some new content would be locally available.

In another embodiment, the scheduler module 211 can receive and/or determine user feedback on the fetched content. For example, the user can rate whether the fetched content was useful. Alternatively, the scheduler module 211 can determine what fetched content has been accessed by the applications 109a-109j as a feedback indicator. In many cases, the scheduler module 211 can use the feedback to direct the scheduling of subsequent data requests. In one embodiment, the feedback can also be shared with other devices using collaborative filtering.

The network management platform 103 includes a server notification module 213 to facilitate information preparation on the server-side (e.g., servers providing or otherwise transmitting information responsive to schedule data requests). For example, the server notification module 213 can generate notifications to the respective servers to alert them with respect to when and/or where it is likely that the UE 101 will be completing its scheduled data requests to update its local storage or cache with pre-fetched content. In one embodiment, the notification (e.g., if it includes anticipated location of the UE 101) can cause the server to transmit at some of the responsive information to an intermediate device (e.g., a router or local device) that can relay the information to the UE 101 when it enters a high-bandwidth network area. In some embodiments, the intermediate device may directly transfer the pre-fetched content using non-data network means (e.g., a local wired or wireless connection between the UE 101 and the intermediate device).

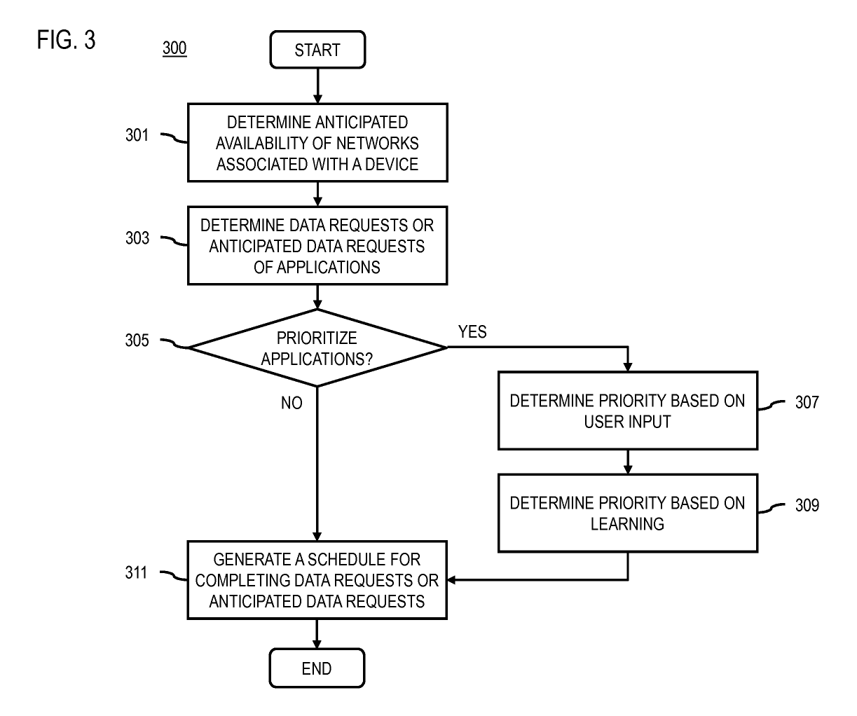

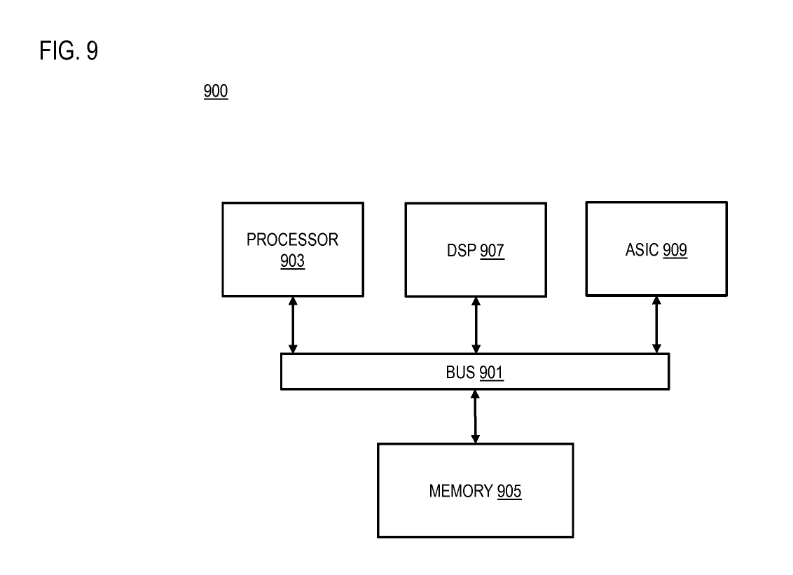

FIG. 3 is a flowchart of a process for generating a schedule for fetching data based on network conditions, according to one embodiment. In one embodiment, the network management platform 103 performs the process 300 and is implemented in, for instance, a chip set including a processor and a memory as shown FIG. 9. In addition or alternatively, the network manager 107 may perform all or a portion of the process 300. In step 301, the network management platform 103 determines an anticipated availability of one or more networks associated with a UE 101.

Next, the network management platform 103 determines one or more data requests, one or more anticipated data requests, or a combination thereof of one or more applications 109a-109j associated with the UE 101 (step 303).

In one embodiment, the network management platform 103 determines whether to prioritize the applications 109a-109j and/or their corresponding data requests, anticipated data requests, or a combination thereof (step 305). If the network management platform 103 determines to establish a priority, the platform 103 can, in one embodiment, determine a prioritization of the applications 109a-109j, the one or more data requests, the one or more anticipated data requests, or a combination thereof based on explicit user input (step 307). In addition or alternatively, the prioritization can be based on one or more learning algorithms that process, for instance: (1) historical use data of the applications 109a-109j; (2) context information (e.g., location information, activity information, time, date, etc.) associated with the UE 101, the applications 109a-109j, the data requests, or a combination thereof or a combination thereof (step 309). In one embodiment, the historical use data, context information, or both may be associated with and/or obtained from other UEs 101 and their respective applications and data requests.

The network management platform 103 then determines to generate a schedule for completing the one or more data requests, the one or more anticipated data requests, or a combination thereof based, at least in part, on the anticipated availability information, the prioritization, or a combination thereof (step 311).

In one embodiment, to generate the schedule, the network management platform 103 determines respective bandwidth capacities, respective bandwidth limitations, or a combination thereof of the one or more networks based, at least in part, on input from one or more network operators, one or more users of the UE 101, one or more other users of other devices, or a combination thereof. In another embodiment, the network management platform 103 determines historical availability information of the one or more networks with respect to the UE 101. The platform 103 then determines the anticipated availability information based, at least in part, on the historical availability information.

In yet another embodiment, the network management platform 103 determines a duration of the anticipated availability based, at least in part, on the respective bandwidth capacities, the respective bandwidth limitations, the historical availability information, or a combination thereof. In one embodiment, the schedule is further based, at least in part, on the anticipated duration of the network availability.

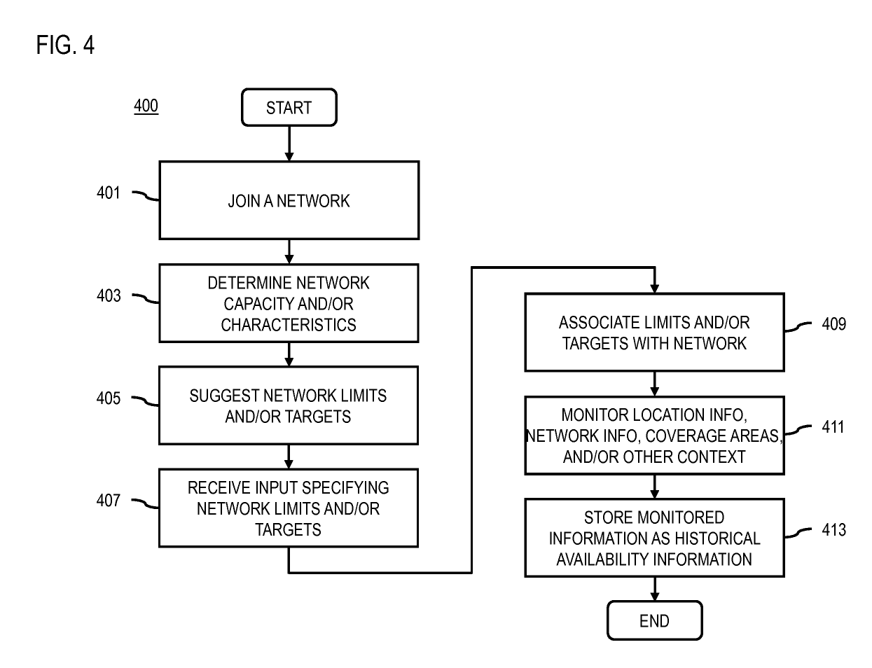

FIG. 4 is a flowchart of a process for determining characteristics of a network for fetching data, according to one embodiment. In one embodiment, the network management platform 103 performs the process 400 and is implemented in, for instance, a chip set including a processor and a memory as shown FIG. 9. In addition or alternatively, the network manager 107 may perform all or a portion of the process 400. In step 401, the network management platform 103 detects a new network and receives a request to join the network. On joining the network, the network management platform 103 determines at least a network capacity and/or other characteristics or conditions (e.g., network name, QoS, etc.) of the network (step 403). In one embodiment, the network capacity and/or other characteristics may be determined at the UE 101 or obtained from one or more other UEs 101.

Based on the determined characteristics or conditions, the network management platform 103 may suggest or recommend network limits and/or targets for accessing the newly joined network (step 403). As previously discussed the network limits may be recommended to facilitate load-balancing of the network (step 405). In addition or alternatively, the recommendations can be based on collaborative filtering of recommendations provided to and/or applied by other users. In step 407, the network management platform 103 may also receive input from the user for specifying the network limits and/or targets. In one embodiment, the recommended limits may be applied as a default configuration or setting. Any manually inputted limits can then override the default settings and be associated with the newly joined network for purposes of determining network availability (step 409).

In some embodiments, the network management platform 103 may determine additional characteristics of the network by monitoring location information and/or network identifiers (e.g., identifiers associated with networks detected and/or identified at the UE 101) associated with the UE 101, and the one or more coverage areas of the network (step 411). This monitoring information can be used, for instance, to determine when the location information and/or network identifiers indicate that the UE 101 is within the one or more coverage areas of the network, is expected to be within the one or more coverage areas, or a combination thereof. By evaluating the patterns of the monitoring information, the network management platform 103 may anticipate or predict when and for how long the monitored network will be available to the UE 101. In one embodiment, the monitoring information and/or anticipated availability of the network may be stored as historical availability information for the network (step 413).

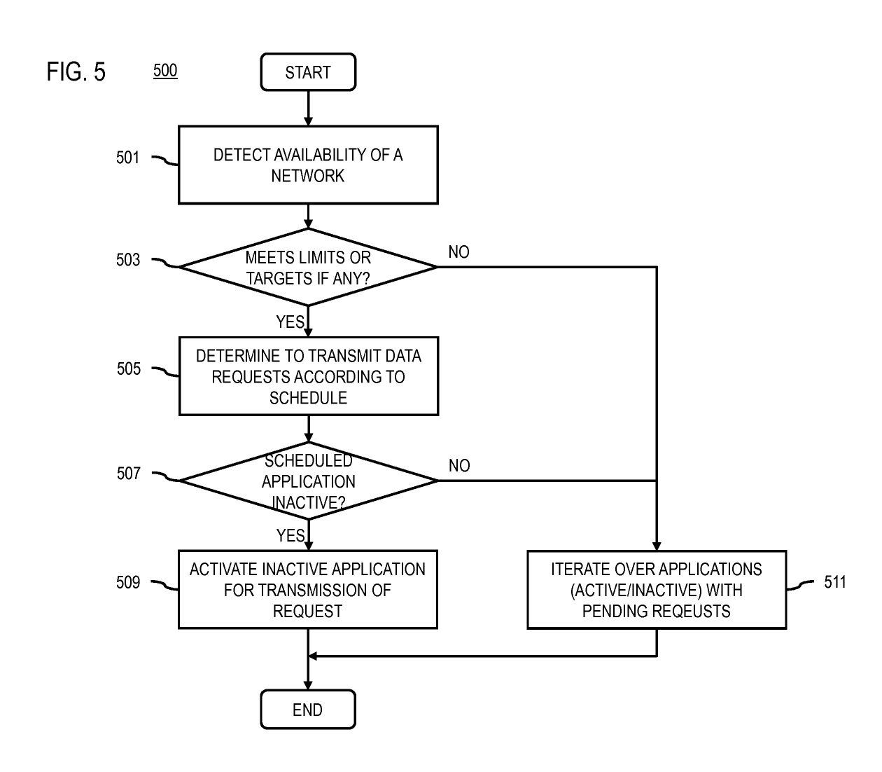

FIG. 5 is a flowchart of a process for determining to transmit data requests based on network conditions, according to one embodiment. In one embodiment, the network management platform 103 performs the process 500 and is implemented in, for instance, a chip set including a processor and a memory as shown FIG. 9. In addition or alternatively, the network manager 107 may perform all or a portion of the process 500. In step 501, the network management platform 103 detects an availability of at least one of the one or more networks monitored and/or joined by the UE 101. In one embodiment, the detection is based, at least in part, on whether the UE 101 has any network connectivity to the network. On detecting the network, the network management platform 103 determines whether there are any previously stored network limits or targets associated with the network. The platform 103 then determines whether the network meets predetermined network conditions, limits, or targets (e.g., minimum available bandwidth, maximum network costs, etc.) (step 503). If the network does not meet the limits or targets, the process 500 ends.

If the network is available and meets the predetermined limits and targets, the network management platform 103 determines to transmit at least one of the one or more data requests, the one or more anticipated data requests, or a combination thereof over the at the network according to the schedule (step 505). If any of the scheduled data requests are associated with an application that is in an inactive state (e.g., dormant or not executed) (step 507), the network management platform 103 determines to activate the inactive application based, at least in part, on the schedule. In this way, even if the application is inactive, the application can nonetheless be placed in an active state so that it can transmit it data requests and receive responsive information or content when a network is available (step 509). In one embodiment, the network management platform 103 can iteratively perform the process 300 until, for instance, the data requests have been satisfied (e.g., content has been delivered in response to the requests from all or substantially all active and/or inactive applications with pending requests), until the network is no longer available, until predetermined bandwidth targets and/or limits have been met, or the like (step 511).

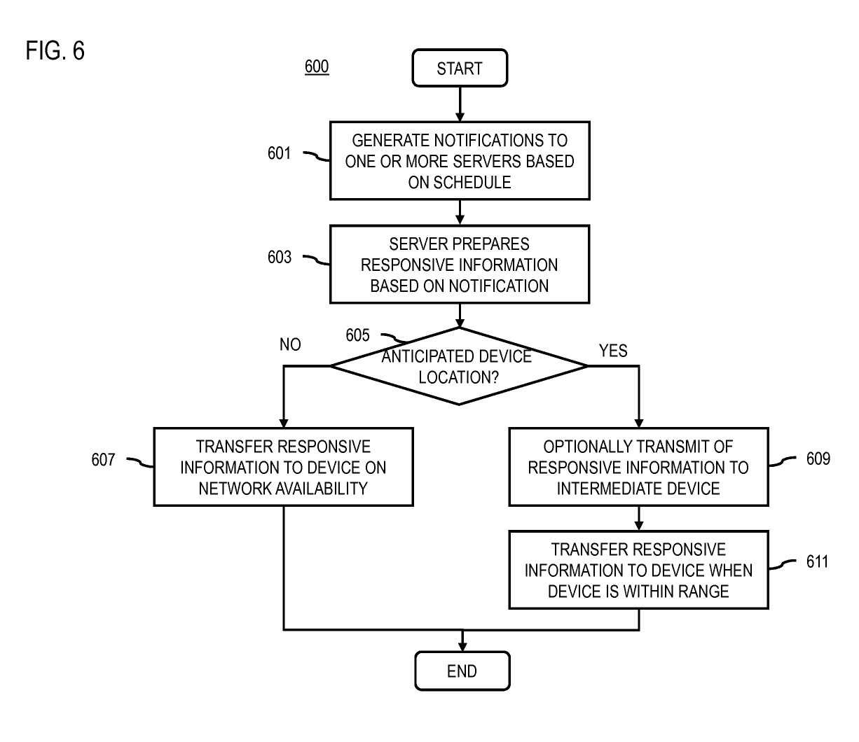

FIG. 6 is a flowchart for generating notifications to servers providing responsive information to data requests, according to one embodiment. In one embodiment, the network management platform 103 performs the process 600 and is implemented in, for instance, a chip set including a processor and a memory as shown FIG. 9. In addition or alternatively, the network manager 107 may perform all or a portion of the process 600. In step 601, the network management platform 103 determines to generate a notification to one or more servers (e.g., the service platform 113, services 115a-115n, content providers 117a-117m) with access to information responsive to at least a portion of the one or more data requests, the one or more anticipated data requests, or a combination thereof based, at least in part, on the schedule. The notification, for instance, alerts the one or more servers to prepare at least a portion of the information for transmission to the UE 101 according to the schedule.

In step 603, the server prepares the responsive information based on the notification. For example, in some embodiments, the notification includes an anticipated time for when the UE 101 is expected to have network availability. Accordingly, at or near the expected time, the server can begin making the preparations so that when the UE 101 makes the data request as expected, the serve can respond more quickly. In some embodiments, the notification may also include the anticipated location of the device in addition to the anticipated time (step 605). If no device location is included in the notification, the network management platform 103 determines to cause, at least in part, actions that result in the transfer of the responsive information from the server to the UE 101 on detection of network availability for the UE 101 (step 607).

If the notification includes the anticipated location of the UE 101, the network management platform 103 can optionally determine to cause, at least in part, actions that result in the transmission of the responsive information to an intermediate device as previously described (step 609). In this way, the network management platform 103 can then initiate the transfer of the responsive information from the intermediate device to the UE 101 when the UE 101 has network connectivity or is within range or alternate communication means (e.g., a local wired or wireless connection such as short range wireless, near field communication, USB connection, etc.) with the intermediate device (step 611).

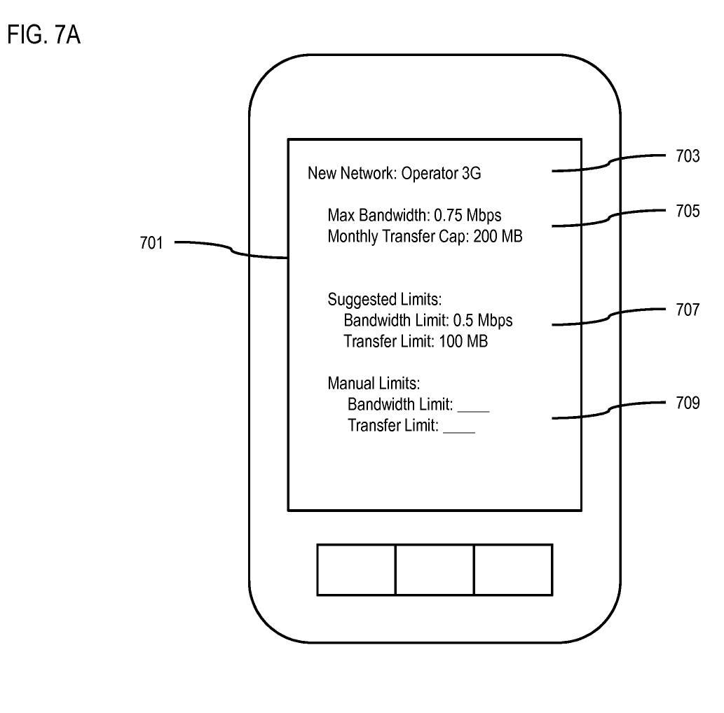

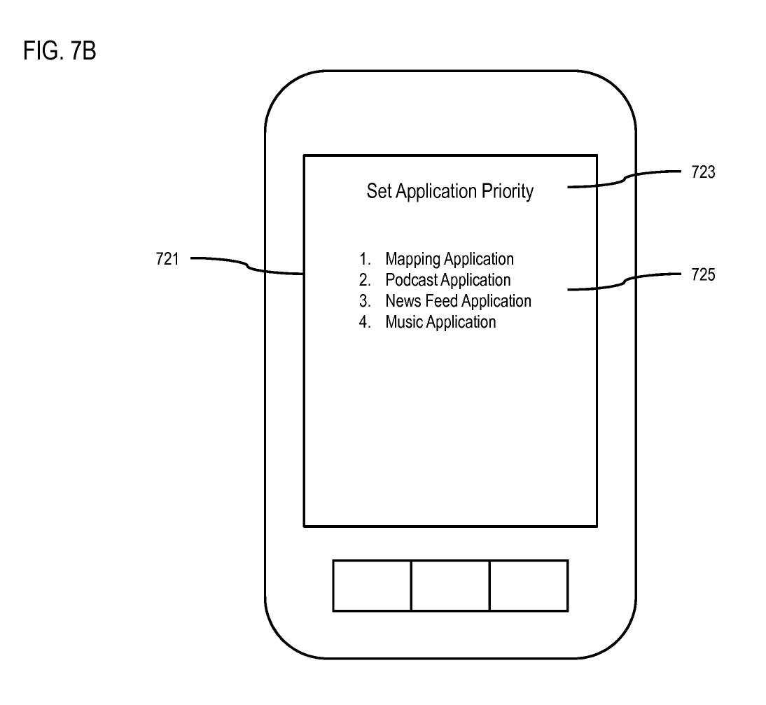

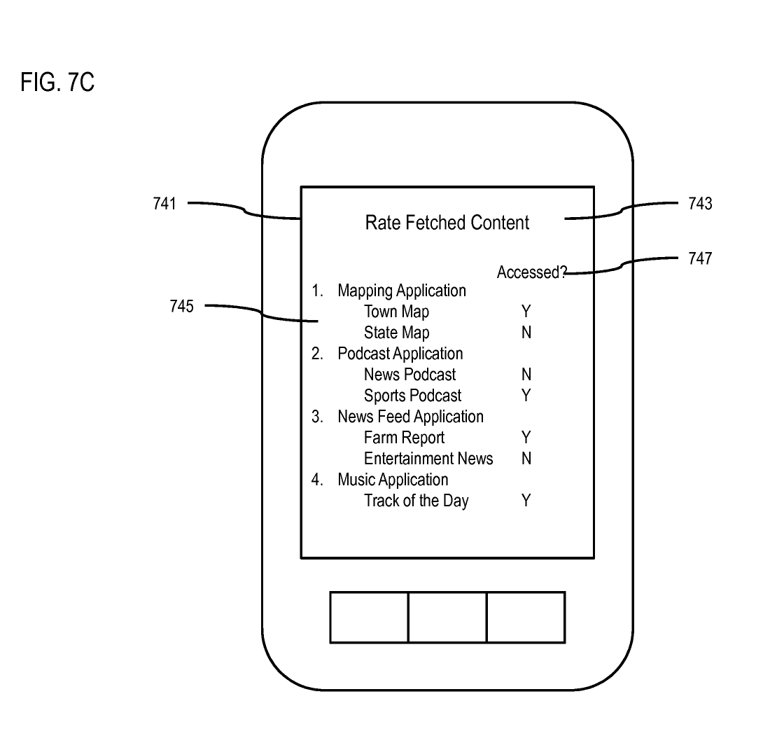

FIGS. 7A-7C are diagrams of user interfaces utilized in the processes of FIGS. 3-5, according to various embodiments. FIG. 7A depicts a user interface 701 for specifying limits or targets for a newly joined or detected network. In one embodiment, the limits or targets (e.g., bandwidth limitations, network cost limits, time limits, etc.) are enforced by the network management platform 103 to determine the availability of the new network. As shown, the user interface 701 displays an information screen for a newly detected or joined network. The title 703 identifies the name of the new network as “Operator 3G.” A section 705 identifies characteristics of the network as determined from or reported by the network operator. In this example, the Operator 3G network has a maximum bandwidth speed of 0.75 Mbps with a monthly transfer cap of 200 MB total. Any transfers over the transfer cap will, for instance, incur additional data transfer charges imposed by the network operator.

Based on these determined characteristics, the network management platform 103 generates recommended limits and presents them in section 707. In this example, to reduce the potential for data overage charges, the network management platform 103 suggests a bandwidth limit of 0.5 Mbps and a transfer limit of 100 MB. Based on typical transfer sizes, the suggested limits will enable the UE 101 or corresponding applications 109a-109j to pre-fetch enough content to satisfy many anticipated data requests without exceeding the devices maximum limits. The user can nonetheless override or ignore the suggested limits by input manual limits in section 709.

FIG. 7B depicts a user interface 721 for prioritizing applications and their pending and anticipated data request. In this example, the user interface 721 enables users to explicitly prioritize applications for fetching data. The prioritization, for instance, determines which applications should receive preferential treatment when there is sufficient network availability (e.g., when the UE 101 is in a high bandwidth environment). The user interface 721 provides a title 723 to indicate that it is for setting application priorities. A section 725 then displays a strict ordering of the applications according to priority. In some embodiments, data requests for each application can also be presented to the user and prioritized individually or in combination. In another embodiment, the manual prioritization can be used by the network management platform 103 to learn and then predict priorities for other applications that may execute on the UE 101.

In one embodiment, the network management platform 103 need not follow the prioritization strictly. For example, the network management platform 103 may use the prioritization in conjunction with other context information (e.g., historical use information, user feedback, etc.) to allocate or schedule the transfer of content during network availability periods. In another embodiment, if no prioritization is specified or if the applications are prioritized equally, the network management platform 103 may divide the anticipated duration of the network availability equally.

FIG. 7C depicts a user interface 741 for rating fetched content. As shown, the user interface 741 includes an identifying title 743 and a fetched content list 745. In this example, the fetched content list 745 organizes the content or data according to the requesting applications. For example, content pre-fetched for the mapping application includes a town map and a state map. The content list 745 also includes a column 747 for indicating whether the user has accessed any of the pre-fetched content. The rating is provided by indicating either a “Y” for yes or an “N” for no in the column 747. In another embodiment, the rating may be provided as a score or importance (e.g., on a scale of 1 to 10) to the applications, the individual data components, or both. It is contemplated that the network management platform 103 may employ any metric or system for indicating a rating for the applications and/or data. Based on the feedback rating, the network management platform 103 can refine scheduling and prioritization of the data requests. By way of example, the network management platform 103 can increase the priority of data requests for content similar to the content that was accessed and decrease the priority for content similar to the ones that were not accessed. It is contemplated that the rating/feedback process can be applied periodically to further improve the accuracy or relevance of the prioritization of the data requests from the applications.

The processes described herein for fetching data based on network conditions may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

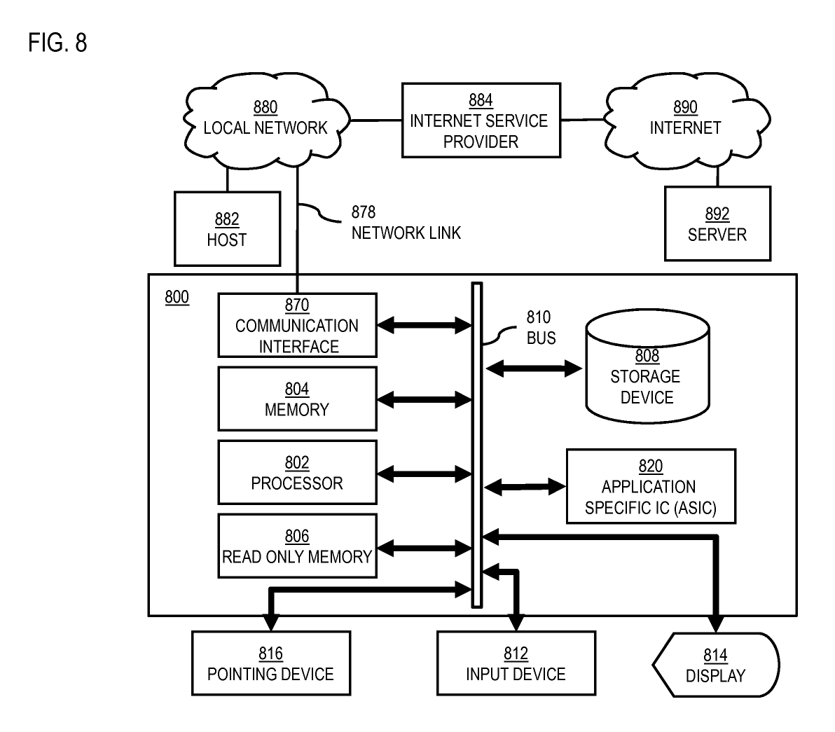

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to fetch data based on network conditions as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of fetching data based on network conditions.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to fetching data based on network conditions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for fetching data based on network conditions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for fetching data based on network conditions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for fetching data based on network conditions.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to fetch data based on network conditions as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of fetching data based on network conditions.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to fetch data based on network conditions. The memory 905 also stores the data associated with or generated by the execution of the inventive steps.

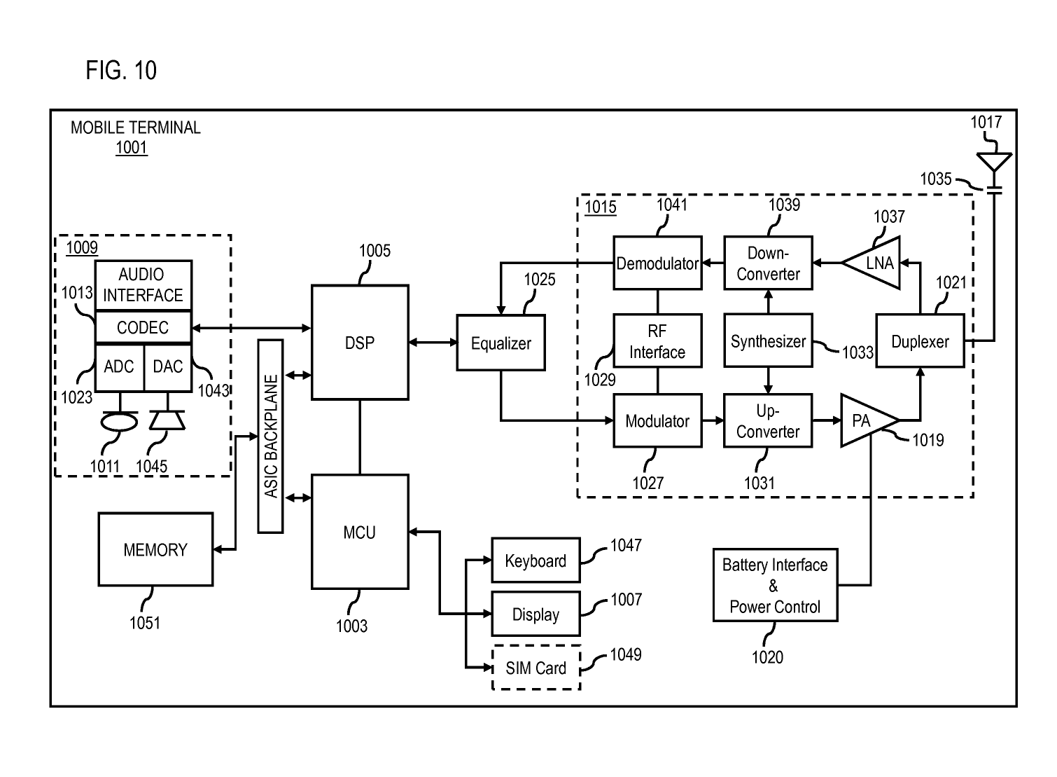

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of fetching data based on network conditions. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of fetching data based on network conditions. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to fetch data based on network conditions. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining an anticipated availability of one or more networks associated with a device;
determining one or more data requests, one or more anticipated data requests, or a combination thereof of one or more applications associated with the device; and
determining to generate a schedule for completing the one or more data requests, the one or more anticipated data requests, or a combination thereof based, at least in part, on the anticipated availability.

2. A method of claim 1, further comprising:
determining respective bandwidth capacities, respective bandwidth limitations, or a combination thereof of the one or more networks based, at least in part, on input from one or more network operators, one or users of the device, one or more other users of other devices, or a combination thereof; and
determining a duration of the anticipated availability based, at least in part, on the respective bandwidth capacities, the respective bandwidth limitations, or a combination thereof,
wherein the schedule is further based, at least in part, on the duration.

3. A method of claim 1, further comprising:
receiving feedback information on at least one of the one or more data requests, the one or more anticipated data requests, or a combination thereof; and
determining one or more subsequent data requests, one or more subsequent anticipated data requests, or a combination thereof based, at least in part, on the feedback information.

4. A method of claim 1, further comprising:
determining historical availability information of the one or more networks with respect to the device,
wherein the anticipated availability is based, at least in part, on the historical availability information.

5. A method of claim 4, further comprising:
determining to monitor location information, one or more network identifiers, or a combination thereof associated with the device; and
determining to monitor one or more coverage areas of the one or more networks with respect to, at least in part, the location information, the one or more network identifiers, or a combination thereof,
wherein the historical availability information includes, at least in part, one or more results of the monitoring.

6. A method of claim 1, further comprising:
detecting an availability of at least one of the one or more networks; and
determining to transmit at least one of the one or more data requests, the one or more anticipated data requests, or a combination thereof over the at least one network according to the schedule based, at least in part, on the detected availability.

7. A method of claim 1, further comprising:
determining that at least one of the one or more applications is in an inactive state; and
determining to activate the at least one application based, at least in part, on the schedule.

8. A method of claim 1, further comprising:
determining a prioritization of the one or more applications, the one or more data requests, the one or more anticipated data requests, or a combination thereof,
wherein the schedule is further based, at least in part, on the prioritization.

9. A method of claim 8, wherein the prioritization is based, at least in part, on user input, historical use data, context information, or a combination thereof associated with the device, one or more users of the device, one or more other users of other devices, or a combination thereof.

10. A method of claim 1, further comprising:
determining to generate a notification to one or more servers with access to information responsive to at least a portion of the one or more data requests, the one or more anticipated data requests, or a combination thereof based, at least in part, on the schedule,
wherein the notification alerts the one or more servers to prepare at least a portion of the information for transmission to the device based, at least in part, on the schedule.

11. An apparatus comprising:
at least one processor; and
at least one memory including computer program code,
the at least one memory and the computer program code configured to, with the at least one processor, cause the apparatus to perform at least the following,
determine an anticipated availability of one or more networks associated with a device;
determine one or more data requests, one or more anticipated data requests, or a combination thereof of one or more applications associated with the device; and
determine to generate a schedule for completing the one or more data requests, the one or more anticipated data requests, or a combination thereof based, at least in part, on the anticipated availability.

12. An apparatus of claim 11, wherein the apparatus is further caused to:
determine respective bandwidth capacities, respective bandwidth limitations, or a combination thereof of the one or more networks based, at least in part, on input from one or more network operators, one or users of the device, one or more other users of other devices, or a combination thereof; and
determine a duration of the anticipated availability based, at least in part, on the respective bandwidth capacities, the respective bandwidth limitations, or a combination thereof,
wherein the schedule is further based, at least in part, on the duration.

13. An apparatus of claim 11, wherein the apparatus is further caused to:
receive feedback information on at least one of the one or more data requests, the one or more anticipated data requests, or a combination thereof; and
determine one or more subsequent data requests, one or more subsequent anticipated data requests, or a combination thereof based, at least in part, on the feedback information.

14. An apparatus of claim 11, wherein the apparatus is further caused to:
determine historical availability information of the one or more networks with respect to the device,
wherein the anticipated availability is based, at least in part, on the historical availability information.

15. An apparatus of claim 14, wherein the apparatus is further caused to:
determine to monitor location information, one or more network identifiers, or a combination thereof associated with the device; and
determine to monitor one or more coverage areas of the one or more networks with respect to, at least in part, the location information, the one or more network identifiers, or a combination thereof,
wherein the historical availability information includes, at least in part, one or more results of the monitoring.

16. An apparatus of claim 11, wherein the apparatus is further caused to:
detect an availability of at least one of the one or more networks; and
determine to transmit at least one of the one or more data requests, the one or more anticipated data requests, or a combination thereof over the at least one network according to the schedule based, at least in part, on the detected availability.

17. An apparatus of claim 11, wherein the apparatus is further caused to:
determine that at least one of the one or more applications is in an inactive state; and
determine to activate the at least one application based, at least in part, on the schedule.

18. An apparatus of claim 11, wherein the apparatus is further caused to:
determine a prioritization of the one or more applications, the one or more data requests, the one or more anticipated data requests, or a combination thereof,
wherein the schedule is further based, at least in part, on the prioritization.

19. An apparatus of claim 18, wherein the prioritization is based, at least in part, on user input, historical use data, context information, or a combination thereof associated with the device, one or more users of the device, one or more other users of other devices, or a combination thereof.

20. An apparatus of claim 11, wherein the apparatus is further caused to:
determine to generate a notification to one or more servers with access to information responsive to at least a portion of the one or more data requests, the one or more anticipated data requests, or a combination thereof based, at least in part, on the schedule,
wherein the notification alerts the one or more servers to prepare at least a portion of the information for transmission to the device based, at least in part, on the schedule.

21-46. (canceled)
